(19) United States
(12) Patent Application Publication
(10) Pub. No.: US 2022/0254263 A1
(43) Pub. Date: Aug. 11, 2022

(54) INTERACTIVE PLATFORM FOR INTERCONNECTION BETWEEN ALL THE EDUCATION SYSTEMS IN THE WORLD

(71) Applicant: Mohidine El Tamame COLY, Dakar (SN)

(72) Inventor: Mohidine El Tamame COLY, Dakar (SN)

(21) Appl. No.: 17/440,801

(22) PCT Filed: Mar. 20, 2019
(86) PCT No.: PCT/IB2019/000199

§ 371 Date: Apr. 14, 2022

(51) Int. Cl. G09B 5/00; G06Q 50/20

(52) U.S. Cl. CPC G09B 5/00; G06Q 50/20

(57) ABSTRACT

The invention relates to an interactive platform for interconnection between all the education systems in the world. It is based on the use of elements that are known in the field of computer science: —Web and mobile applications —XELTAB electronic board —Devices for viewing all the participants of the educational systems taken into consideration by the web and mobile application and the XELTAB —Simultaneous translation device. The invention works by implementing connection interfaces represented by boards that appear in the description.

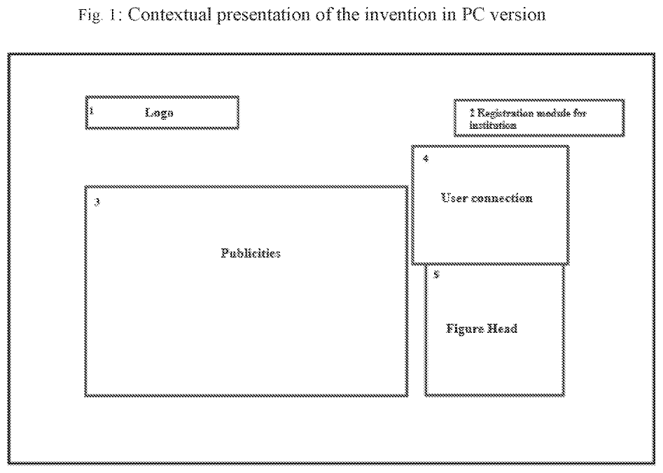

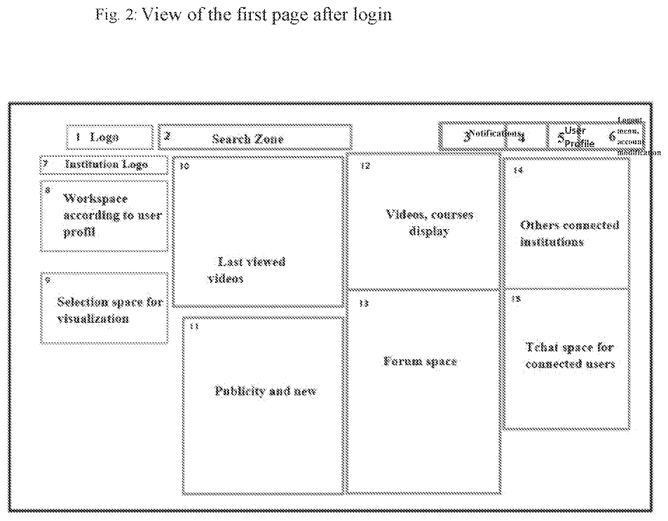

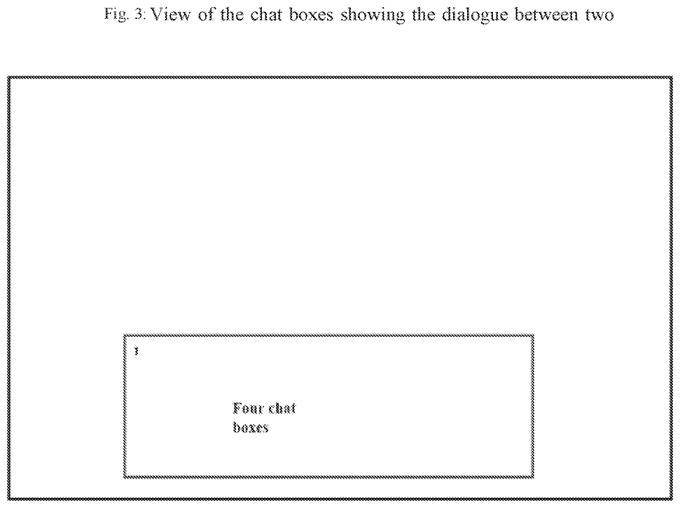

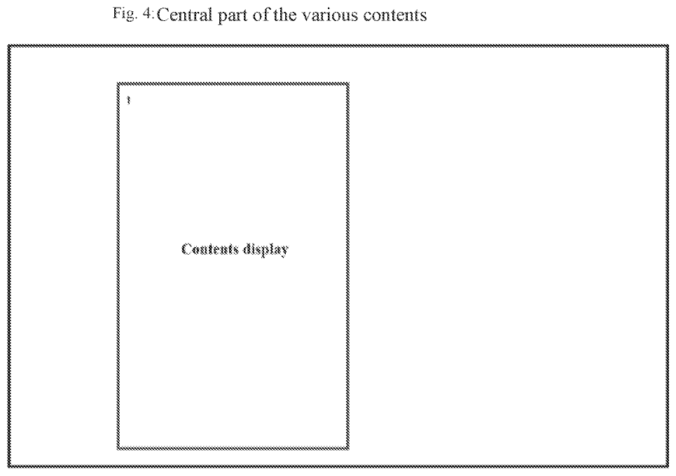

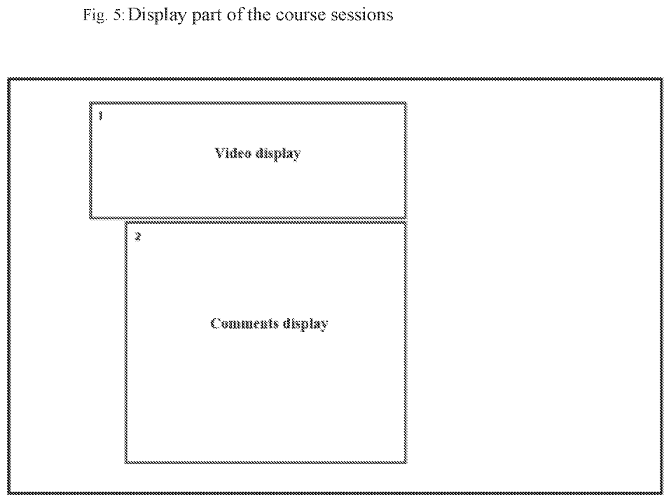

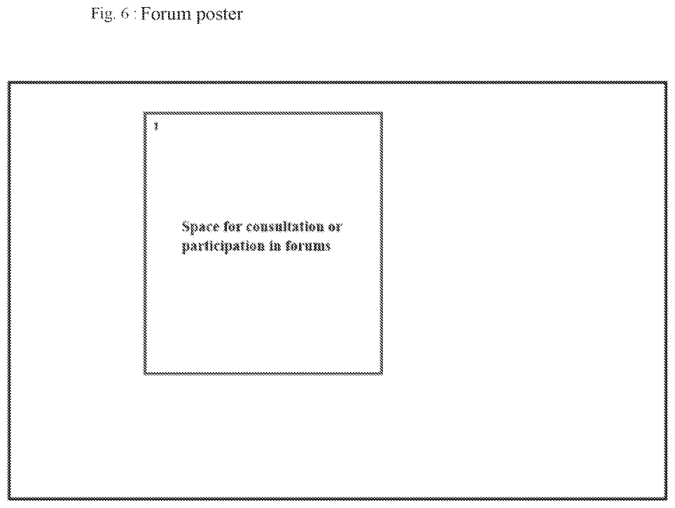

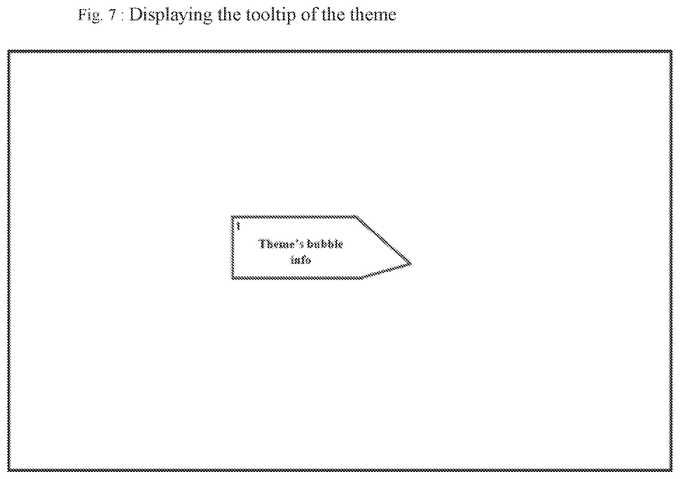

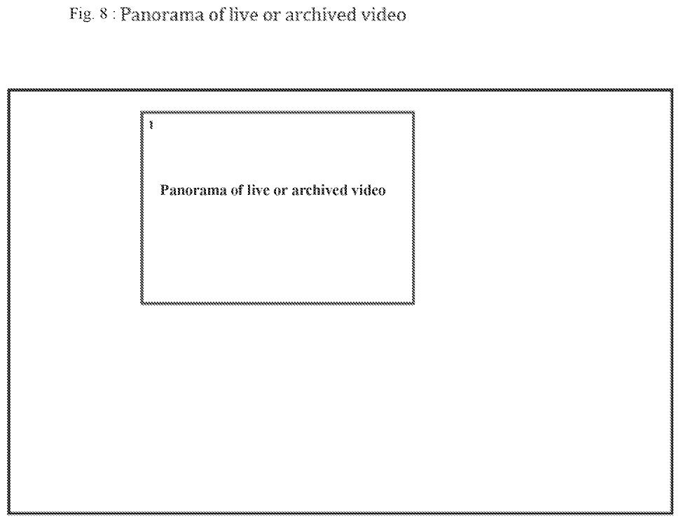

The present invention concerns an interactive platform for interconnection between all the educational systems of the world, regardless of the country in which one is located.

### A. PROBLEMS THAT THE INVENTION SEEKS TO SOLVE

In the context of globalization that is required in all areas, there are fewer and fewer cross-border barriers, and therefore competition is required everywhere regardless of the sector of activity you choose.

Hence the urgent need to improve skills so that each actor, whatever his level of involvement, is better equipped to face this competition and to interact in such a way as to promote economic progress seen in a globalized dimension.

States and international institutions have understood this imperative and are addressing it by trying to reform the education system so that guidance corroborates the phenomenon of globalization.

And as the performance of universities and other educational institutions is measured in relation to international education systems, we find it an opportunity to create a system that provides a platform for collaboration between all education systems in the world so that it is possible, at any time, to produce reliable and instantaneous statistics.

It is also stated that until now the possibilities offered by web and mobile engines have not been used for the interconnection of education systems programmes.

### B. STATE OF THE ART KNOWN TO THE INVENTOR

The following sources of scientific and technical information relating to the subject-matter of the invention were investigated:
a. Sources of scientific information other than patents:
   Wikipedia open classroom platform
   Electronic Easy Learning lynda.com
   Open online course etc. . . .
   Mooc
   Facebook Interconnection System
b. Source of scientific and technical information on patents
1. Interactive memorial system
   US2017036105—2017 Feb. 9
2. Communication using interactive avatars
   US2017039751—2017 Feb. 9
3. Interactive system for use in connection with the identification and/or management of psychological issues
   AU2017200849—2017 Feb. 23
4. Detection of potential security Threats based on categorical patterns
   US2017048265—2017 Feb. 16
5. Method and apparatus for pen reader hypermedia system with mobile communication
   TW200732938—2007
6. Method and apparatus for USB mobile learning pen
   TW200732937—2007 Sep. 1
7. System and method for broadcasting personalized and where applicable interactive contents to terminals attached to a communication network
   TW200729874—2007 Aug. 1
8. Multi-directional network real-time remote controlled interactive learning toy
   TW200713904—2007 Apr. 1
9. Interactive digital broadcasting system for personal matching and method thereof
   TW200701677—2007 Jan. 1
10. Interactive communication system method and device
   TW201635841—2016 Oct. 1
11. System and method for interactive metadata and intelligent propagation for electronic multimedia
   US2017024791—2017 Jan. 26
12. Application framework for interactive ligth sensor networks
   CA2952856—2015 Dec. 16
13. Communication device and method between and audiovisual information tenyback system and an electronic game machine
   US2016199735
14. Data distribution system, data acquisition device, writing device, date, acquisition program, data acquisition method media and data distribution device
   TW200506684

### I. DESCRIPTION

1. Constituent elements

The invention is a new use of devices known from the field of computer science. This is
Web and mobile applications
XELTAB Electronic Board
Visualization devices for all actors of the education systems taken into consideration by the web and mobile application and the XELTAB
Of simultaneous translation device.

2. Operation

The invention works through the implementation of connection interfaces represented by the following plates:

Plate 1: Presentation

Caption:
1. Logo
2. Facility Registration Module
3. Scrolling advertising on the front page
4. User Login
5. Iconic figure

Plate 2: The view of the first page after login:

Caption:
1. Logo
2. Search Area
3. And 4 notifications
4. User Profile
5. Logout menu, account modification
6. Establishment logo
7. Workspace as per user profile
8. Space for selecting objects to be viewed
9. Fixed part of last viewed videos
10. Advertising space and news
11. Video space and courses of partner or connected institutions
12. Forum space for partner or connected institutions
13. Connected partner facility spaces
14. Chat area for connected users

Plate 3: View of the chat boxes tracing the dialogue between two users

Caption:
1. Four chat boxes

Plate 4: View of the task part, central part for viewing the different contents

Legend
1. Central display space for different contents

Plate 5: View of the Online or Archived Course Session View

Legend
1. Display part of the video
2. Comments Display Portion

Plate 6: View part poster forums

Legend
1. Space for consultation or participation in forums

Plate 7: Display view of the forum theme tooltip

Legend
1. the tooltip to display the total content of the forum theme

Plate 8: View of video widgets

Legend
1. Panorama of live or archived videos.

3. The features of the invention

The invention combines several features organized by strands:

Education, Social network, health, statistics, advertising, sale of non-personalized information, security and geo-location.
Education: Xeledring offers:
   the interconnection of establishments,
   a virtual space connecting the main actors (students, teachers, parents, members of the administration, etc.) via mobile phone or computer,
   the sharing of resources,
   Writing recognition technology (Xeltab) that eliminates paper and chalk at school.
Social network: here, we are talking about:
   instant messaging otherwise known as chat
   phone calls, video calls, and video conferencing
   unified messaging (sms, fax and email)
Health: This Xeledring interface offers:
   Logistics to enable interaction between medical specialists and various sensors installed in the Xeltab tables to diagnose the health status of students, teachers and administrators.
Statistics: Xeledring has an evaluation module for:
   Quantify the education system of any country in real time with reliable, clear and automatic statistics. This information may be sold within a political-legal framework.
Advertising: the main source of revenue, this module identifies and invoices all advertising actions taken by advertisers according to the type of offer chosen on the basis of a multitude of selected targets. The billing methods will be either by click (cpc), by print (cpm), by wind (cpv), by purchase (cpa) etc. . . . the module consists of:
   Xel navigation: billing on the navigation page
   Mobile xel: billing by type of mobile (ipad, iphone, android tablet, android, etc.)
   Xel login: billing on the connection page (picture or video depending on the format)
   Video xel: trueview insplay/instream: billing for graphic or video elements passed by the advertiser before, during or just after an event video
   Xel slide: transparent tape billing on video or next to event video
   Xel overplay: billing by transparent tape on the video or next to the event video.
Security and geo-location: the geo-location interface offers:
   the ability to track smart laptops (ipad, iphone, smartphone, etc.) regardless of the brand, to combat device theft.

I claim:

1. Interactive platform for interconnection between education systems.

2. Interactive platform for interconnection between education systems according to claim 1 characterised in that it consists of new use of devices known to the computer field: on the same tab are gathered all the technology of Facebook, Google and YouTube.

3. Interactive platform for interconnection between education systems according to claim 2 characterised in that several connection interfaces are developed for the implementation of the invention.

4. Interactive platform of interconnection between education systems according to claim 1 characterized in that it allows the instantaneous quantification of education systems with automatic, clear and reliable statistics on different electronic devices (computers, electronic boards, smart phone, Ipod, etc.)

5. Interactive platform of interconnection between education systems according to claim 2 characterized in that it allows the instantaneous quantification of education systems with automatic, clear and reliable statistics on different electronic devices (computers, electronic boards, smart phone, Ipod, etc.)

6. Interactive platform of interconnection between education systems according to claim 3 characterized in that it allows the instantaneous quantification of education systems with automatic, clear and reliable statistics on different electronic devices (computers, electronic boards, smart phone, Ipod, etc.)
